(19) United States
(12) Patent Application Publication
(10) Pub. No.: US 2022/0111993 A1
(43) Pub. Date: Apr. 14, 2022

(54) Polymeric Spirits Container

(71) Applicant: AMCOR RIGID PACKAGING USA, LLC, Ann Arbor, MI (US)

(72) Inventors: Jonathan P. JARMAN, Ann Arbor, MI (US); Myles GRAYBILL, South Lyon, MI (US)

(21) Appl. No.: 17/555,307

(22) Filed: Dec. 17, 2021

Related U.S. Application Data
(62) Division of application No. 16/096,015, filed on Oct. 24, 2018.

(51) Int. Cl. B65D 1/02; C08L 101/00; B65D 85/72

(52) U.S. Cl. CPC B65D 1/0207; B65D 85/72; B65D 1/0246; C08L 101/00

(57) ABSTRACT

A method for filling a container configured to store spirits or drink mixers therein. The method includes: arranging the container on a filling line configured to fill 750 ml glass containers, the container is a polymeric container having a capacity of at least 1 liter, the container including: a finish defining an opening, a body, a neck and a shoulder between the finish the body, and a base including a standing surface; and filling the container with a spirit or drink mixer using equipment set to fill 750 ml glass spirits containers. The container has a maximum outer diameter between about 2.5 inches and about 3.5 inches. The finish has an inner diameter at the opening of between about 0.65 inches to about 0.85 inches, thereby configuring the finish to accept a pour spout of a 750 ml glass spirits container.

### CROSS-REFERENCE TO RELATED APPLICATIONS

This patent application is a divisional patent application of U.S. application Ser. No. 16/096,015 (35 USC 371(c)(1) date of Oct. 24, 2018), which claims the benefit and priority of International Application No. PCT/US2016/029117 filed on Apr. 25, 2016. The entire disclosures of all of these applications are incorporated herein by reference.

### FIELD

The present disclosure relates to a polymeric container configured to store spirits, drink mixers, or other liquids for use at a bar.

### BACKGROUND

This section provides background information related to the present disclosure, which is not necessarily prior art.

While current glass spirits containers are suitable for their intended use, they are subject to improvement. For example, glass spirits containers are undesirably heavy, subject to shattering, and costly to ship. Furthermore, glass spirits containers of different capacities, such as 750 ml and 1 ml, cannot be filled with the same equipment due to their different exterior dimensions, such as different diameters, and undesirably require different pour spouts having different diameters.

It would therefore be desirable to have a spirits container that weighs less than existing glass containers, is shatter resistant, and is less costly to ship as compared to existing glass containers. It would further be desirable to have a 1 L or larger spirits container that can be filled with the same equipment used to fill standard 750 ml glass spirits containers, and can be used with a standard 750 ml pour spout. This is because 750 ml is currently the standard size for glass spirits and mixer containers. Glass 1 L containers have diameters that are larger than 750 ml containers, which makes 1 L glass containers unable to be filled by equipment configured to accommodate 750 ml containers. As a result, to fill 1 L glass spirits and mixer containers, the filling line must be shut down and reconfigured to accommodate the 1 L containers, which causes fillers to lose valuable machine operating time, and adds to production costs. The present teachings advantageously provide for polymeric spirits and mixer containers that address the aforementioned needs and shortcomings in the art, as well as numerous others.

As a result of environmental and other concerns, plastic containers, more specifically polyester and even more specifically polyethylene terephthalate (PET) containers, are being used more than ever to package numerous commodities previously supplied in glass containers. Manufacturers and fillers, as well as consumers, have recognized that PET containers are lightweight, inexpensive, recyclable, and manufacturable in large quantities.

Blow-molded plastic containers have become commonplace in packaging numerous commodities. PET is a crystallizable polymer, meaning that it is available in an amorphous form or a semi-crystalline form. The ability of a PET container to maintain its material integrity relates to the percentage of the PET container in crystalline form, also known as the “crystallinity” of the PET container. The following equation defines the percentage of crystallinity as a volume fraction:

$$\% Crystallinity = ( \frac{ρ - {ρ}_{a}}{{ρ}_{c} - {ρ}_{a}} ) \times 100$$

where ρ is the density of the PET material; ρₐ is the density of pure amorphous PET material (1.333 g/cc); and ρ_{c} is the density of pure crystalline material (1.455 g/cc).

Container manufacturers use mechanical processing and thermal processing to increase the PET polymer crystallinity of a container. Mechanical processing involves orienting the amorphous material to achieve strain hardening. This processing commonly involves stretching an injection molded PET preform along a longitudinal axis and expanding the PET preform along a transverse or radial axis to form a PET container. The combination promotes what manufacturers define as biaxial orientation of the molecular structure in the container. Manufacturers of PET containers currently use mechanical processing to produce PET containers having approximately 20% crystallinity in the container's sidewall.

Thermal processing involves heating the material (either amorphous or semi-crystalline) to promote crystal growth. On amorphous material, thermal processing of PET material results in a spherulitic morphology that interferes with the transmission of light. In other words, the resulting crystalline material is opaque, and thus, generally undesirable. Used after mechanical processing, however, thermal processing results in higher crystallinity and excellent clarity for those portions of the container having a biaxial molecular orientation.

### SUMMARY

This section provides a general summary of the disclosure, and is not a comprehensive disclosure of its full scope or all of its features.

The present teachings include a method for filling a container configured to store spirits or drink mixers therein. The method includes: arranging the container on a filling line configured to fill 750 ml glass containers, the container is a polymeric container having a capacity of at least 1 liter, the container including: a finish defining an opening, a body, a neck and a shoulder between the finish the body, and a base including a standing surface; and filling the container with a spirit or drink mixer using equipment set to fill 750 ml glass spirits containers. The container has a maximum outer diameter between about 2.5 inches and about 3.5 inches. The finish has an inner diameter at the opening of between about 0.65 inches to about 0.85 inches, thereby configuring the finish to accept a pour spout of a 750 ml glass spirits container.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a polymeric container, such as for spirits or drink mixers, according to the present teachings;

FIG. 2 is a cross-sectional view of a finish of the container of FIG. 1;

FIG. 3 is a cross-sectional view of area 3 of FIG. 1 showing a sidewall of the container of FIG. 1; and

FIG. 4 is a perspective view of the container of FIG. 1 modified to include flutes at a shoulder portion of the container.

Corresponding reference numerals indicate corresponding parts throughout the several views of the drawings.

### DETAILED DESCRIPTION

Example embodiments will now be described more fully with reference to the accompanying drawings.

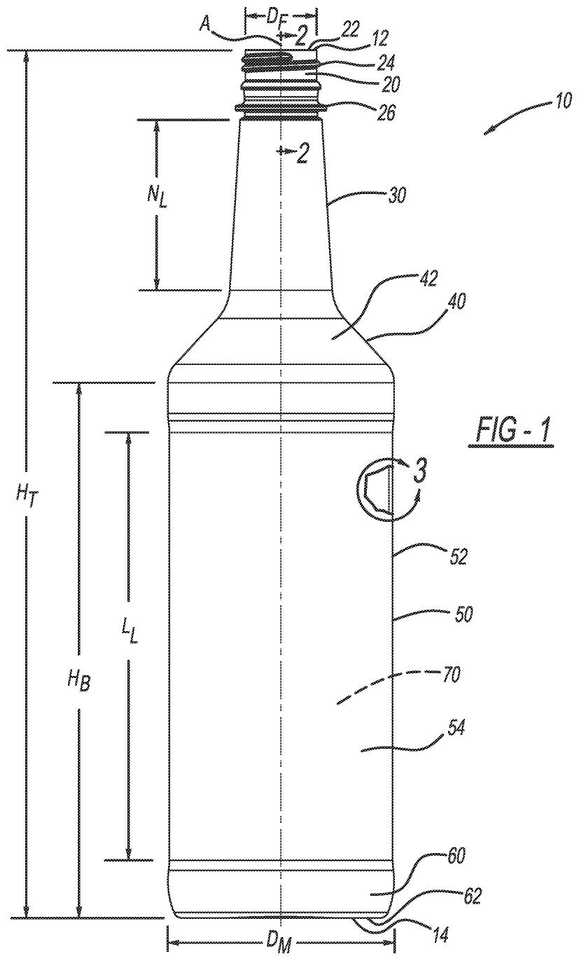

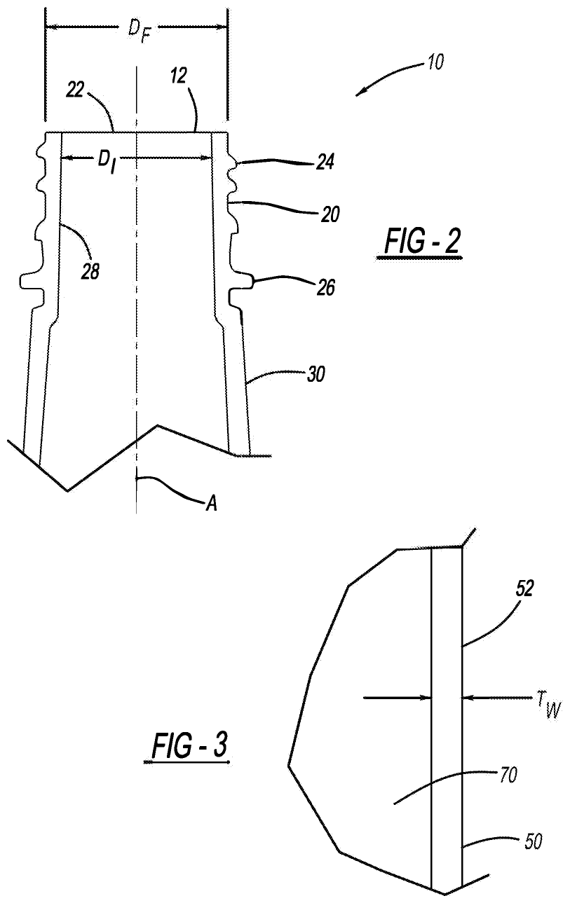

With initial reference to FIGS. 1 and 2, a polymeric container according to the present teachings is generally illustrated at reference numeral 10. The container 10 can store any suitable product, such as any suitable liquid product. The container 10 is particularly configured to store spirits or drink mixers, and is particularly suited for bar use. The container 10 is a round container having a capacity of at least 1 L, but can have any other suitable shape, such as any suitable shape to accommodate filling equipment used to fill the container 10, such as filling equipment used to fill smaller 750 ml capacity glass containers as described herein.

The container 10 can be formed to have any suitable capacity, such as a capacity greater than 750 ml. In particular, the container 10 can be configured to have a capacity of at least 1 liter, such as 1 liter or about 1 liter, or 1.14 liters or about 1.14 liters, or up to 1.75 liters or about 1.75 liters. The container 10 can be made of any suitable material, such as polyethylene terephthalate (PET), low-density polyethylene (LDPE), high-density polyethylene (HDPE), polypropylene (PP), or polystyrene (PS). The container 10 can be formed in any suitable manner, such as with any suitable blow-molding process, for example.

The container 10 generally includes a first end 12 and a second end 14, which is opposite to the first end 12. At the first end 12 is a finish 20, which defines an opening 22 of the container 10 through which contents of the container 10 can be loaded into the container 10, or dispensed from within the container 10. A longitudinal axis A of the container 10 extends through a radial center of the opening 22. Extending outward from an outer surface of the finish 20 are threads 24. The threads 24 are configured in any suitable manner to cooperate with any suitable closure such as a 28 mm closure, which when in cooperation with the threads 24 will extend across the opening 22 to close and seal the opening 22. A flange 26 extends outward from the container 10, and can be configured to support a preform of the container 10 in a mold during blow-molding of the container 10. The finish 20 can be configured in any suitable manner to cooperate with any suitable closure, such as a short closure, a tall closure, a roll-on pilfer proof (ROPP) closure, a swing-top closure, or a bar-top closure, or any other custom closure.

Extending from the finish 20 towards the second end 14 is a neck 30 of the container 10. The neck 30 extends along the longitudinal axis A of the container 10, and generally tapers outward from the longitudinal axis A as the neck 30 extends from the finish 20 to a shoulder 40 of the container 10. Thus the neck 30 is most narrow proximate to the finish 20, and widest proximate to the shoulder 40.

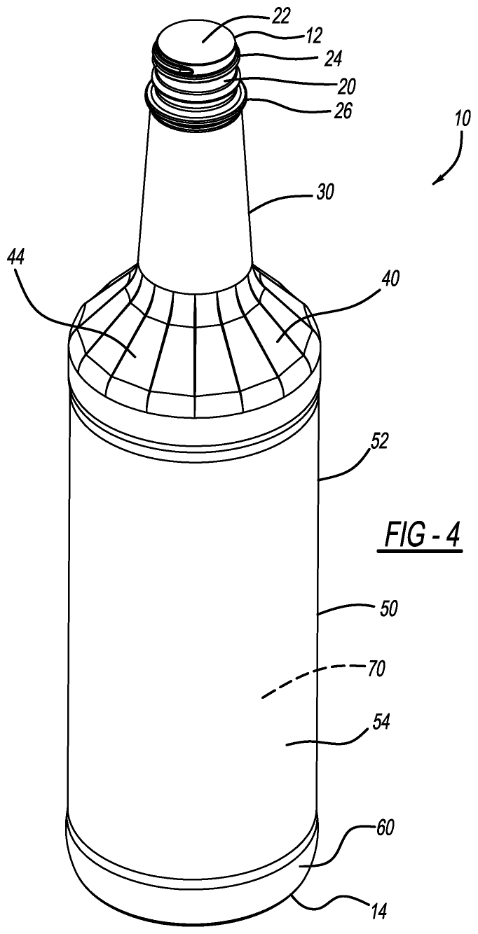

The shoulder 40 tapers outward from the longitudinal axis A as the shoulder 40 extends from the neck 30 to a body 50 of the container 10. The shoulder 40 can include a smooth surface 42 as illustrated in FIG. 1, or a fluted surface 44 as illustrated in FIG. 4, or any other customized surface or shape. The shoulder 40 is most narrow proximate to the neck 30, and is widest proximate to the body 50.

The body 50 extends from the shoulder 40 to a base 60 of the container 10. The body 50 includes an outer wall 52, which defines a portion of an internal volume 70 of the container 10. The outer wall 52 is generally circular.

The base 60 includes a standing surface 62 at the second end 14, which is configured to support the container 10 in an upright position when the container 10 is seated on a suitably flat surface. The base 60 can be any suitable type of base. For example, any suitable rigid base can be used, such as any suitable non-vacuum absorbing base.

The container 10 is dimensioned such that even though it has a capacity of 1 liter or more, such as 1 liter or 1.14 liters, the container 10 can be filled with equipment configured to fill standard 750 ml glass spirits containers. Specifically, the container 10 has a maximum outer diameter D_{M} that is the same as, or generally the same as, 750 ml spirits containers. The maximum outer diameter D_{M} is between 2.5 inches, or about 2.5 inches, to 3.5 inches, or about 3.5 inches. In particular, the maximum outer diameter D_{M} is about 3.1 inches, such as 3.115 inches. The container 10 also has a total height H_{T} as measured between the first and second ends 12 and 14 that is less than 13 inches so as to allow the container 10 to be seated on shelves configured to accommodate standard 750 ml spirits containers. Having a total height H_{T} of less than 13 inches also advantageously allows the container 10 to be filled by filling equipment configured to fill 750 ml spirits containers. The container 10 can have any suitable height less than 13 inches or less than 12.8 inches, such as a total height H_{T} of 12.3 inches, or about 12.3 inches. The container 10 has a total height H_{T} that is 4 times greater than, or about 4 times greater than, the maximum outer diameter D_{M}.

The container 10 is further dimensioned with a base and body height HB measured from the second end 14 to where the body 50 meets the shoulder 40. The height HB can be any suitable height, such as 7.7 inches, or about 7.7 inches. The total height H_{T} of the container 10 is about 1.6 times greater than the height HB. The body 50 includes a label portion 54 to which a container label is typically affixed. The label portion 54 has a length LL of between about 5 inches to about 6 inches, or 6.2 inches, or about 6.2 inches, or any other suitable length.

With continued reference to FIG. 1 and additional reference to FIG. 2, the finish 20 has a diameter D_{F} of 0.98 inches, or about 1.0 inches, as measured at the outside edges of the first end 12. The finish 20 has an inner diameter D_{I} of 0.65″ to 0.85″. For example, the inner diameter D_{I} proximate to the opening 22 can be 0.775 inches, or about 0.78 inches. The finish 20 has an inner surface 28 that tapers inward towards the longitudinal axis A as the finish 20 extends from the first end 12 towards the neck 30.

The finish 20, and particularly the inner surface 28 thereof, is configured to accommodate a pour spout to facilitate pouring contents out from within the container 10. The pour spout can be any pour spout configured for use with a 750 ml glass spirits container. Thus, the finish 20, and particularly the inner surface 28 at the inner diameter D_{I}, is dimensioned, shaped, and generally configured to accommodate a pour spout dimensioned for use with any suitable prior art 750 ml glass spirits container.

The neck 30 has a length NL extending parallel to the longitudinal axis A. The length NL extends from where the neck 30 transitions to the shoulder 40, to where the neck 30 transitions to the finish 20, just below the flange 26. The neck length NL can be any suitable length, such as 2.3 inches, or about 2.3 inches. The neck 30 can have a length NL configured to accommodate any suitable spirits or drink mixer label. The neck length NL of the neck 30, as well as the slope of the shoulder 40, can be varied to provide the container 10 with any desirable shape, such as a shape corresponding to a glass bottle that the particular spirit or drink mixer is typically sold in.

With reference to FIG. 3, the outer wall 52 of the container 10 can have any suitable thickness. For example, at the body 50, the outer wall 52 can have a wall thickness Tw of about 0.01 inches to about 0.05 inches. The wall thickness Tw is less than a glass container wall thickness, thereby advantageously providing the container 10 with additional volume capacity without having to increase the maximum diameter D_{M}, and only minimally increasing the total height H_{T}. For example, the height HB can be minimally increased as compared to 750 ml glass containers, thereby increasing the internal volume 70 at the body 50.

Forming the container 10 of a polymeric material provides the container 10 with numerous advantages over glass containers. For example, the container 10 is about 80% lighter than similarly sized glass containers. As a result, the container 10 is advantageously less costly to ship as compared to glass containers, often times resulting in a 20% cost savings per truckload. The container 10 can have any suitable unfilled weight, such as between about 50 grams and about 90 grams. For example, the container 10 can have an unfilled weight of 79 grams, or about 79 grams.

The container 10 is advantageously shatter resistant. Thus the container 10 will not shatter or break during filling, which results in less material waste and increased filling efficiencies. In contrast, about 1% to 5% of glass containers break during the filling process, which results in wasted material and lost production time because the production line must be shut down each time a container breaks to clean up the broken glass and spilled contents.

Because the polymeric container will not break, there is no need to separate neighboring containers by a divider or a partition when being shipped or stored. As a result, multiple polymeric containers 10 can be positioned closer together, and may abut one another, thereby allowing additional containers to be loaded onto each truck, effectively increasing the container capacity of each truck. Eliminating the divider between containers further reduces shipping costs because there is no need to spend money on dividers.

The dimensions of the container 10 set forth above advantageously allow the container 10 to be run through a glass bottling line configured to fill 750 ml glass containers so that the container 10 can be filled by existing equipment, and so that a line filling 750 ml glass containers need not be shut down and significantly reconfigured to accommodate larger containers of 1 liter or more, as is currently the case, which undesirably increases manufacturing costs.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method for filling a container configured to store spirits or drink mixers therein, the method comprising:
arranging the container on a filling line configured to fill 750 ml glass containers, the container is a polymeric container having a capacity of at least 1 liter, the container including: a finish defining an opening, a body, a neck and a shoulder between the finish the body, and a base including a standing surface; and
filling the container with a spirit or drink mixer using equipment set to fill 750 ml glass spirits containers;
wherein the container has a maximum outer diameter between about 2.5 inches and about 3.5 inches, thereby configuring the container to be filled by equipment set to fill 750 ml glass spirits containers; and
wherein the finish has an inner diameter at the opening of between about 0.65 inches to about 0.85 inches, thereby configuring the finish to accept a pour spout of a 750 ml glass spirits container.

2. The method of claim 1, further comprising applying a label to the neck of the container.

3. The method of claim 1, further comprising closing the container by securing a closure to threads at the finish of the container, the closure including a 28 mm closure.

4. The method of claim 1, further comprising inserting the pour spout in the opening for dispensing the spirit or drink mixer from the container.

5. The method of claim 1, wherein the container is made of polyethylene terephthalate.

6. The method of claim 1, wherein the container has an internal volume capacity of 1 L.

7. The method of claim 1, wherein the container has an overall height of less than 13 inches.

8. The method of claim 1, wherein the container has an overall height of less than 12.8 inches.

9. The method of claim 1, wherein the container has an overall height of about 12.3 inches.

10. The method of claim 1, wherein the container has a height from a standing surface of the base to the shoulder of about 7.7 inches.

11. The method of claim 1, wherein an overall height of the container is about 1.6 times greater than a height of the container as measured from a standing surface of the base to the shoulder.

12. The method of claim 1, wherein the maximum outer diameter of the container is about 3.1 inches.

13. The method of claim 1, wherein the container has a height to diameter ratio of about 4:1.

14. The method of claim 1, wherein the finish has an inner diameter at the opening of the finish of about 0.78 inches.

15. The method of claim 1, wherein the container weighs between about 50 and about 90 grams unfilled.

16. The method of claim 1, wherein the container weighs about 59 g or about 79 g unfilled.

17. The method of claim 1, wherein the neck has an overall length of about 2.2 inches to about 2.4 inches.

18. The method of claim 1, wherein body includes a label panel having a length of about 5 inches to about 6 inches.

19. The method of claim 1, wherein the body has a wall thickness of about 0.01 inches to about 0.05 inches.

20. The method of claim 1, wherein the shoulder includes a plurality of flutes.

21. A method of forming and filling a polyethylene terephthalate container with a capacity of at least 1 liter configured to store spirits or drink mixers therein, the method comprising:
injection molding a preform;
blow molding the preform into a container using a two-step blow molding process, wherein the container has a finish including threads defining an opening of the container, a neck extending from the finish, a shoulder extending from the neck, a body extending from the shoulder, and a base including a standing surface of the container, the body extending from the base to the shoulder;
filling the container using equipment configured to fill 750 mL glass containers;
closing the container by securing a closure to the threads; and
applying a body label to the body of the container.

22. The method of claim 21, wherein the opening is configured to receive a pour spout configured for 750 mL glass containers for dispensing the spirits or drink mixers.

23. The method of claim 22, further comprising inserting the pour spout into the opening.

24. The method of claim 21, further comprising applying a neck label to the neck of the container.

25. The method of claim 21, wherein the container has an overall height as measured from the standing surface of the base to the opening of the container of less than 13 inches.

26. The method of claim 21, wherein the container has a maximum outer diameter of the container is 3.1 inches.

27. The method of claim 21, wherein the overall height of the container is 1.6 times greater than a height of the container as measured from the standing surface of the base to the shoulder.

28. The method of claim 21, wherein the container has an overall height to maximum outer diameter ratio of about 4:1.

29. The method of claim 21, wherein and the container has a weight between 50 grams and 90 grams.

30. The method of claim 21, wherein the container has an overall height of about 12.3 inches.

31. The method of claim 21, wherein the container has the height from the standing surface of the base to the shoulder of 7.7 inches.

32. The method of claim 21, wherein the closure is a 28 mm closure.

33. The method of claim 21, wherein the finish has an inner diameter at the opening of the finish of 0.65 inches to 0.85 inches.

34. The method of claim 21, wherein the container weighs between 50 and 90 grams unfilled.

35. The method of claim 21, wherein the container weighs between 59 g and 79 g unfilled.

36. The method of claim 21, wherein the neck has an overall length of 2.2 inches to 2.4 inches.

37. The method of claim 21, wherein, wherein body includes a label portion having a length of 5 inches to 6 inches.

38. The method of claim 21, wherein the body has a wall thickness of 0.01 inches to 0.05 inches.
